(19) United States
(12) Patent Application Publication
(10) Pub. No.: US 2025/0367715 A1
(43) Pub. Date: Dec. 4, 2025

(54) ARTIFICIAL TURF RECYCLING APPARATUS SYSTEM AND METHODS

(71) Applicant: New Planet Energy Development LLC, St. Louis, MO (US)

(72) Inventors: Ryan Bird, South Oceanview, NJ (US); Donald Kerik, Sparta, NJ (US)

(21) Appl. No.: 19/216,254

(22) Filed: May 22, 2025

Related U.S. Application Data
(60) Provisional application No. 63/653,092, filed on May 29, 2024.

(51) Int. Cl. B09B 3/30; B03C 1/18; B03C 1/22; B03C 1/30; B07B 1/00; B09B 3/40; B09B 101/80

(52) U.S. Cl. CPC B09B 3/30; B03C 1/18; B03C 1/22; B03C 1/30; B07B 1/005; B09B 3/40; B03C 2201/20; B09B 2101/80

(57) ABSTRACT

An artificial turf recycling system and method includes multi-phase processing of shredded turf laden with infill from an 8 inch minus product size down to about 1 mm minus particle size or less with a combination of special purpose equipment. Clean processed sand and crumb rubber may efficiently and expeditiously be reused in the installation of replacement artificial turf. Mobile apparatus and equipment may optionally be utilized proximate the site of the artificial turf needing replacement.

### CROSS REFERENCE TO RELATED APPLICATIONS

This application claims the benefit of U.S. Provisional Application Ser. No. 63/653,092 filed May 29, 2024 the complete disclosure of which is hereby incorporated by reference in its entirety.

### BACKGROUND OF THE INVENTION

The field of the invention relates generally to material recycling apparatus, systems and methodology for reclaiming intermixed construction materials, and more specifically to artificial turf infill recycling and reclamation apparatus, systems, and methodology.

Artificial turf, sometimes referred to as synthetic turf, is now in widespread use as a practical alternative to natural turf, sometimes referred to as natural grass. Artificial turf may rival the beauty of manicured natural turf while avoiding certain limitations of natural turf, and its use has therefore expanded considerably in recent times to provide attractive and functional ground cover in a variety of settings.

For example, natural turf requires ongoing maintenance including fertilizing, watering, and cutting of grass to maintain its beauty and suitability whereas artificial turf eliminates such maintenance. Use and enjoyment of natural turf is also limited by weather and seasonal conditions whereas artificial turf is less affected. Specifically, natural turf may freeze in cold weather and become undesirable, if not practically unusable, for certain activities while artificial turf remains substantially unaffected and is desirably available for use.

Natural turf may also become rather delicate and vulnerable to damage in wet conditions, and consequently the use of natural turf may sometimes be delayed or interrupted by rain events whereas artificial turf presents no comparable concern. Generally speaking, natural turf athletic fields for football, soccer, field hockey, lacrosse, etc. present an increased likelihood of damage in all conditions which may require still further maintenance, restriction and repair in the ongoing use of the natural turf and/or more severe restrictions when and whether the natural turf may be used for sporting activity. Artificial turf tends to be much more resistant to damage overall, and is less subject to rain-related restrictions. As a result, artificial turf has been increasingly adopted for playing fields, not just in collegiate and professional sport settings, but in primary and secondary schools, municipal parks, and other public and private recreational centers. Apart from sporting applications, the benefits of artificial turf versus natural turf also apply to parks and playgrounds, as well as residential properties and commercial properties.

Modern artificial turf includes synthetic fibers secured to a backing, with an infill material interspersed between the fibers to stably support the fibers with a desired degree of cushioning while otherwise resembling natural grass. The backing is laid over a base such as gravel or another material facilitating drainage when it rains. The infill material may include sand, rubber and/or other materials, depending on the performance characteristics desired.

Certain types of known artificial turf surfaces have a useful life of about eight to ten years, after which they are typically replaced. A recycling of artificial turf materials at the time of replacement is desirable and a variety of recycling systems and methods have been proposed. Known artificial turf recycling systems and methods suffer from certain disadvantages that have yet to be completely overcome.

Specifically, the practicality of artificial turf recycling depends on the speed of removing artificial turf from the site where it was installed, the speed of separating the materials utilized in the artificial turf, the quality of the materials recovered, and the market value of those materials for re-use. Existing artificial turf recycling machinery, systems and methods generally suffer from being inefficiently slow, overly complicated, and/or prohibitively expensive relative to the market for the separated materials.

For example, self-propelled machinery is known that is designed to remove artificial turf from its point of installation after the artificial turf is cut into long strips that may be about 7 feet wide. The machinery lifts the artificial turf, removes infill material from a carpet backing of the turf, and rolls the carpet backing into a compact form. See, e.g,, the TurfMuncher TM2000D and TM2500E machines of SMG, Vöhringen, Germany available at the links https://www.smg-gmbh.de/en/turf/reclamation/turfmuncher-tm2000d and https://www.smg-gmbh.de/en/turf/reclamation/turfmuncher-tm2500e. See also the RATTLESNAKE® Infill Separator machine and WINDER™ Turf Roller of Turf Reclamation Solutions, Cincinnati, Ohio available at the link https://turfreclamationsolutions.com/. While such machines can be effective to remove the infill material from the carpet backing, they tend to do so rather slowly, at least in part because they are designed to operate on the artificial turf without prior removal of the turf and to output carpet backing rolls as well as sacks of infill material that are removed from the carpet backing. A desirability of such machinery is apparently premised on the belief that the carpet backing rolls can desirably be re-used, but the inventors have found that there is no re-sale market for the carpet backing rolls in the marketplace. From this perspective, these types of machines are therefore undesirably inefficient to meet the longstanding but unfulfilled needs of the marketplace.

As another example, Re-Match Turf Recycling (https://re-match.com/) has a patented process based on mechanical separation of synthetic turf materials. The patented process cleans synthetic turf components into a level of purity where the sand, rubber, backing and fiber effectively can be used in new production cycles. As understood, the patented process involves rolling of synthetic turf from its point of installation and transferring it to a brick and mortar facility such as a factory wherein the rolls or material are processed to separate the synthetic turf materials. Very fine processing of the materials, including the carpet fibers, is made in order for separated carpet fibers to be recycled and specifically made into yarn which can be used in the production of new synthetic turf. Notwithstanding the appeal of recycling carpet fibers into useful yarn, the inventors believe that this is generally impractical and that the costs of refining and cleaning the synthetic materials to retrieve carpet fibers that can be made into yarn exceeds the available return in the marketplace. As such, the output materials of this type of synthetic turf recycling system and method are believed to be over-processed for the needs of the marketplace and are therefore cost prohibitive. Over-processing of the materials likewise introduces additional delay in making some of the output materials available for re-use, and tends to overcomplicate the machinery and methods utilized.

As an example of over-processing of materials in the Re-Match process, U.S. Pat. No. 9,789,516 describes shredding of turf product in a first shredder to downsize it into a product size of 50 mm, a second shredder to downsize the material to 30 mm, and a third shredder to downsize the material to a product size of 8 mm. Infill material from each of the shredded material product sizes are independently sieved in a relatively complicated manner toward the goal of collecting “completely purified” carpet fibers, “essentially pure” rubber, and “essentially pure” sand. Such multi-stage shredding and sieving entails excessive processing steps and equipment to perform the steps when such completely purified materials is not required for recycling of the materials in another artificial turf system.

Improved artificial turf systems and methods are accordingly desired which are more efficient and provide useful material outputs with a reduced amount of equipment and a reduced number of steps to reclaim desirable material outputs in a reduced time and at lower cost. Specifically, simpler and more effective systems and methods are needed to more rapidly reclaim the constituents of the infill material at a reduced cost for re-use in another artificial turf surface.

### BRIEF DESCRIPTION OF THE DRAWINGS

Non-limiting and non-exhaustive embodiments are described with reference to the following Figures, wherein like reference numerals refer to like parts throughout the various views unless otherwise specified.

FIG. 1 is a schematic diagram of an exemplary artificial turf system and its constituent material components.

FIG. 2 is a block diagram of a first exemplary artificial turf recycling and reclamation system according to an embodiment of the present invention.

FIG. 3 is an exemplary flowchart of method processes performed in the artificial turf recycling and reclamation system shown in FIG. 1.

FIG. 4 is a block diagram of a second artificial turf recycling system according to an embodiment of the present invention.

FIG. 5 schematically illustrates a conveyor belt and air knife arrangement for the system shown in FIG. 4.

FIG. 6 is a schematic conveyor belt and vacuum head arrangement for the system shown in FIG. 4.

FIG. 7 is an exemplary flowchart of method processes performed in the artificial turf recycling and reclamation system shown in FIG. 4.

FIG. 8 is a first perspective view of a mobile apparatus for the artificial turf recycling systems of FIGS. 2 and 4 and showing the apparatus in a compact transport configuration.

FIG. 9 is a second perspective view of the mobile apparatus shown in FIG. 8 in an extended operational configuration on an artificial turf recycling and reclamation site.

FIG. 10 is a side elevational view of the apparatus shown in FIG. 9 with operative recycling and reclamation equipment located thereon.

FIG. 11 is a side elevation view of the apparatus shown in FIG. 10 with recycling and reclamation equipment in a transport configuration.

FIG. 12 is a left-hand view of an exemplary trailer apparatus for the artificial turf recycling systems of FIGS. 2 and 4 and showing the apparatus in a compact transport configuration.

FIG. 13 is a left-hand view of the exemplary trailer apparatus for the artificial turf recycling systems of FIGS. 2 and 4 and showing the apparatus in an operating configuration.

FIG. 14 is a right-hand view of the exemplary trailer apparatus shown in FIG. 12.

FIG. 15 a right-hand view of an exemplary trailer apparatus shown in FIG. 13.

FIG. 16 is a side elevational view of an exemplary shredder machine for the systems and methods described above and for use with the mobile apparatus shown in FIGS. 8-15.

FIG. 17 is a side elevational view of an exemplary trommel screener machine for the systems and methods described above and for use with the mobile apparatus shown in FIGS. 8-16.

FIG. 18 is a material flow schematic diagram for the apparatus shown in FIGS. 8-17 when operating according to the methods of FIGS. 3 and 7.

FIG. 19 schematically shows an exemplary artificial turf system located proximate an exhausted artificial turf system site.

FIG. 20 schematically shows an exemplary artificial turf system at a hub location at a reduced distance from exhausted artificial turf system site.

### DETAILED DESCRIPTION OF THE INVENTION

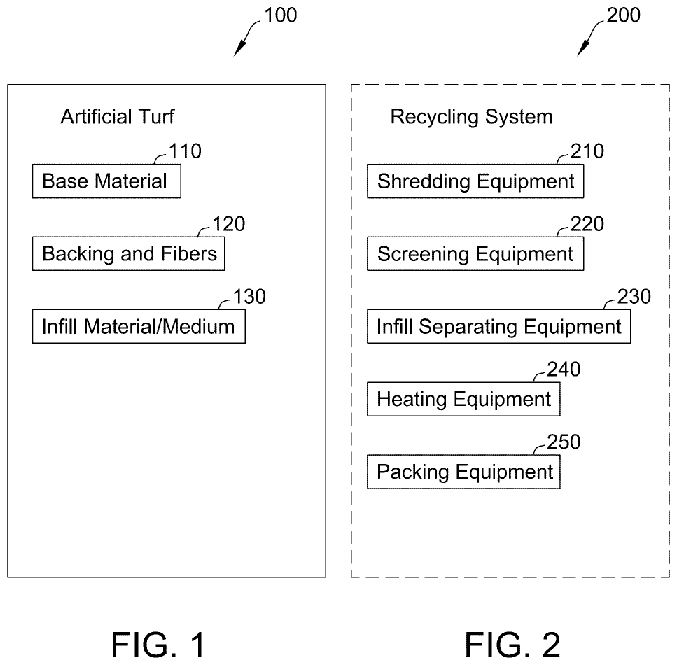

FIG. 1 is a block diagram of an exemplary artificial turf surface/system 100 and FIG. 2 is a block diagram of an artificial turf recycling system 200 according to an exemplary embodiment of the present invention.

As shown in FIG. 1, the artificial turf surface 100 includes a base material 110, a backing and fiber layer 120 extending upon the base material 110, and an infill material/medium 130 interspersed in the backing and fiber layer 120 which stabilizes the fibers in a generally vertical orientation with a desired amount of cushioning. The construction and methodology for installation of the artificial turf surface 100, and any related equipment needed to do so, is generally well-known and familiar to those in the art such that further description thereof will not be further described herein. The backing and fiber layer 120 is sometimes referred to in the art as “carpet” or “carpet backing”.

The artificial turf surface 100 may be configured, sized and dimensioned with any surface treatment (colors, stripes, etc.) as desired for use as an athletic playing field (e.g., football field, soccer field, field hockey court, lacrosse field, etc.), as a playground surface, or as an ornamental surface for a residential home or commercial business as non-limiting examples. The artificial turf surface 100 can in general be configured, sized and dimensioned for any end use or purpose desired and may be provided with or without surface treatments.

At the end of its useful life, the artificial turf surface 100 will require replacement. The artificial turf recycling system 200 may be beneficially employed to efficiently recycle and reclaim materials utilized in the turf surface 100 at lower cost and/or with improved performance than conventional artificial turf recycling and material reclamation systems and methods. Advantageously, the base material 110 can typically be reused with a replacement backing and fiber layer 120 after the exhausted backing and fiber material layer 120 in the existing turf surface 100 is removed. The infill material 130 of an exhausted artificial turf surface 100 may also be desirably re-used with a replacement backing and fiber layer 120 if the infill material 130 can be successfully extracted from the backing and fiber material layer 120 of the exhausted backing and fiber material layer 120. Systems and methods exist to remove and reclaim the infill material 130 for possible re-use in a replacement artificial turf surface, but tend to suffer from one or more issues including undesirably high costs, inefficiencies in processing of materials, and/or quality issues and reliability issues in separating the constituent materials utilized in the exhausted artificial turf surface 100 in an optimal manner.

Typical infill material/medium 130 for the artificial turf surface 100 may include a combination of graded sand, granulated styrene-butadiene rubber (SBR), Thermoplastic Elastomers (TPE's) and Ethylene Propylene Diene Monomers (EPDM's), cork and organic material. Such constituent materials can be utilized in isolation or combined together either in distinct layers or by mixing together. A typical sand/rubber infill material for a high performing artificial turf system can account for 90% of the material in the completed artificial turf surface 100 by weight. Reclamation and reuse of such sand/rubber material can therefore realize significant cost savings in the replacement of the artificial turf surface 100. Because the particle size in the sand/rubber material can impact drainage, cushioning, and comfort of the completed artificial turf surface, as well as detract from the overall appearance of the completed artificial turf surface, careful processing of the inflow material in recycling and material reclamation systems is required to ensure its optimal reuse.

In order to realize the desired material processing for infill material reclamation and recycling at reduced cost, the artificial turf recycling system 200 is mobile in some embodiments. That is, the artificial turf recycling system 200 may be configured to be movable or transportable to a processing site that is adjacent to or otherwise proximate to a site where the exhausted artificial turf surface 100 resides. As such, the exhausted artificial turf surface 100 need not be transported to a centralized processing site farther away for material reclamation processing utilizing equipment that may be permanently located at the centralized processing site. Costs associated with transporting large amounts of artificial turf material to a remote site may therefore be avoided, and associated delay in material reclamation processing due to transporting of material is beneficially avoided. Processing of exhausted artificial turf material at or near the site of the exhausted artificial turf/surface system 100 will likewise desirably avoid the cost of transporting reclaimed inflow material back to the site for use with a replacement backing and fiber layer to reconstruct a replacement artificial turf surface, while also avoiding delay in reconstructing the replacement artificial turf surface associated with transporting reclaimed material back to the reconstruction site.

For the purposes herein, “mobile” or “transportable” equipment shall refer to apparatus and equipment that is brought to the processing location at or near the exhausted artificial turf system site, typically on a wheeled platform associated with a transport vehicle such as a truck or truck and trailer combination but not excluding other types of transport. Further, certain mobile apparatus and equipment in the context of the system 200 may include integrated treads or tracks, wheels or other elements that allow them to move after being unloaded from a truck, a trailer, or other transport vehicle. In some scenarios wherein the equipment is already close to the site of exhausted artificial turf, some pieces of equipment may be driven to the processing location under their own power.

While mobile equipment in the recycling system 200 is advantageous for the reasons stated above, the system 200 may in other contemplated embodiments be embodied in non-mobile apparatus and equipment that is stationary at a centralized site that is not proximate or adjacent to the exhausted artificial turf. In such embodiments, transport of exhausted artificial turf material to the non-mobile system 200 will be required, as well as transport of reclaimed material back to the artificial turf reconstruction site.

In contemplated embodiments, such a non-mobile system may be a permanently located or stationary, brick and mortar facility that may be at some distance from the site of exhausted artificial turf requiring increased transport time and costs. To address the costs and delay of transporting material across great distances, embodiments of mobile apparatus and equipment as described herein may be brought to and located at a desired geographic location sometimes referred to as a “hub” that is not necessarily near or adjacent an exhausted artificial turf system, but which is otherwise closer than a permanently located, brick and mortar facility and which serves as an optimal location for recycling artificial turf systems with a predetermined distance from each site of exhausted artificial turf. In such a hub arrangement, some transport of materials may be required but at a shorter distance that accordingly will lower costs and reduce processing time of artificial turf materials relative to brick and mortar processing sites that are farther away from the sites of exhausted artificial turf systems. Improved efficiencies of turf reclamation processing and improved performance, as well as simplified apparatus and system operation at lower operating cost, is therefore possible in the system 200 relative to certain types of known non-mobile artificial turf recycling systems.

As shown in FIG. 2, the recycling equipment in the system 200 includes shredding equipment 210, screening equipment 220, infill separating equipment 230, heating equipment 240 and packaging equipment 250. The system 200 may also optionally include equipment for cutting and rolling the backing and fiber layer and inlaid infill material/medium in the exhausted artificial turf surface/system 100. While equipment 210, 220, 230, 240 and 250 is shown as separate equipment that may optionally be brought to the processing site as stand-alone equipment units near where the artificial turf resides, or alternatively to the site of the hub where processing may occur, aspects of the equipment shown could be combined in contemplated embodiments, including but not necessarily limited to the heating equipment and infill separating equipment as further discussed below. As such, the number of physical units in the system 200, whether mobile or non-mobile, may be varied in different embodiments.

In contemplated embodiments, installers of the new, reconstructed replacement turf/system may operate known equipment to cut, roll, and move the old, exhausted infill laden turf surface 100. That is, the old, exhausted infill laden turf surface 100 is removed and rolled without separating the constituent materials (i.e., the carpet backing and the infill materials). In a mobile system 200, the installers may also move the rolled material to a designated processing area adjacent or proximate the site of the exhausted turf prior to its removal, or to the location of the hub, while in a non-mobile system the designated processing area is at a fixed location remote from the site of the exhausted turf surface. In the non-mobile system, transport of the shredded turf surface material to a remote designated processing area may be made by the installers or by another party such as the operator of the recycling and reclamation system 200 or an authorized transport service chosen by the installers or the recycling and reclamation system operator. Regardless, the shredding equipment 210 is located at the designated processing site to receive the cut, rolled and removed exhausted artificial turf as an input for reclamation and recycling processing as described herein. In other words, the cut and rolled artificial turf is shredded after it is removed from its point of installation and before any of it is processed to remove the infill material from smaller, shredded pieces of the artificial turf. Consequently, and unlike some known recycling systems and methods, the exhausted artificial turf (i.e., the fiber backing layer including the infill) may be quickly and efficiently removed from the site of the turf surface, reducing the amount of time needed to install a replacement fiber backing layer (i.e., replacement carpet backing) at the site. In other words, infill materials can be separated from the exhausted carpet backing at the processing site while a replacement carpet backing is simultaneously being laid. When the infill material is successfully reclaimed it can be applied to the replacement carpet backing to reduce the time and cost of installing the replacement turf system.

In another contemplated embodiment, the cutting and rolling of turf material may be an aspect of a mobile recycling system 200 and additional equipment may be transported to the site of the exhausted artificial turf for the cutting, rolling and removing with similar benefits. Likewise, in a non-mobile system the exhausted artificial turf surface could be shredded by the shredding equipment 210 near or adjacent the site of the exhausted artificial turf and then be transported to a non-mobile system for further processing. Whether mobile or non-mobile, the shredding equipment 210 in one example is configured to shred the exhausted turf rolls to about an 8 inch (203 mm) minus product including, for example, a mixed sand and crumb rubber infill material 130 in combination with a portion of the backing and fiber layer 120. Such shredding of the material facilitates an efficient processing thereof to subsequently remove the infill material as well as more efficiently collect and remove the carpet and fibers without a more tedious and time consuming rolling of larger pieces of carpet in some conventional systems and methods.

As used herein, an 8 inch minus product means that the largest particle size in the shredded artificial turf material has a dimension that is no larger than about eight inches (203 mm). The largest particle size in the 8 inch minus product would correspond to the backing layer 120 to which the fibers remain attached in the shredded turf, while smaller particles may also include fibers that are no longer attached and infill material that is separated from the backing layer in the shredding process. The 8 inch minus product of the shredded artificial turf rolls is not required in all embodiments, however, and greater or lesser minus product sizes may be obtained instead as desired with the shredding equipment 210 with otherwise similar advantages and benefits. The largest particles in the exemplary 8 inch minus product in the system 200 is about 4 times larger than the shredded material input taught in U.S. Pat. No. 9,789,516 discussed above, significantly reducing processing time and lowering costs of the material processing relative to certain conventional artificial turf recycling processes.

In contemplated embodiments, the shredding equipment 210 is a known mobile or non-mobile industrial shredder apparatus familiar to those in the recycling field. As one example, the shredding equipment 210 may be a known mobile, slow-speed shredder including two synchronously running shredding shafts with tracked undercarriage for propelling and positioning the shredding equipment to a desired location and orientation at the processing site to receive and shred the artificial turf material. Other types of mobile shredders are also known and may likewise be utilized. Since the construction and operation of such mobile shredders is well-known, and also non-mobile shredders that may likewise be employed is well-known, no further explanation of shredding equipment is believed to be necessary. In some embodiments, in lieu of known shredders, the shredder equipment 210 may be a custom fabricated apparatus for the recycling system 200. Exhausted turf roll material may be fed, conveyed, or input to the shredding equipment 210 in any known manner and output into, for example, the 8 inch minus product size. The shredded output may be fed directly into the screening equipment 220 or stockpiled at the processing site for further processing by the screening equipment 220.

The screening equipment 220 may process the shredded turf material through, for example, a ⅜″-¼″ (9.5 mm to 6.35 mm) trommel screen to loosen and remove the sand and crumb rubber infill from the backing and fiber layer 120 (FIG. 1) in the shredded 8 inch minus product size. In contemplated embodiments, the screening equipment 220 may be, for example, a known mobile trommel screen including a spinning drum which lifts, tumbles and drops the 8 inch minus product size to break it into smaller pieces while eventually filtering material through a screen once the broken material is small enough to pass through the screen. In a contemplated embodiment, heat may be applied to the shredded material in the trommel to further component separation and/or to provide for some initial cleaning and/or disinfection of the materials at this stage. The broken material passing through the screen in a minus product size of 9.5 mm to 6.35 mm in this example is about 21 times to about 31 times smaller than the 8 inch (203 mm) minus product size that is input to the screening equipment 220, significantly more than conventional artificial turf recycling systems including initial downsizing of about 10 times in a first stage of recycling system operation that is followed by additional shredding, cutting and or screening steps to reduce the material size in a successive manner with additional equipment. The screening equipment 220 is operative to more simply remove the infill material for further processing in a reduced amount of time relative to conventional systems and methods which include further processing of reduced size turf material to recover additional amounts of the infill material.

Mobile and non-mobile trommel screening machines are known and may be utilized, and in some embodiments the screening equipment 220 may be custom fabricated for the application of the recycling system 200. Regardless, in contemplated embodiments the screening equipment 220 is operative in a first phase of system operation to prescreen the shredded material in order to remove the infill material/medium (e.g., crumb rubber and sand from the backing/fiber layer) in the shredded turf material. The backing/fiber layer output from the screening equipment 220 may be packaged on site for shipping to another location where it can be re-used in any manner desired.

In one contemplated example, the clean backing/fiber layer material may be packaged into supersacks in a known manner and shipped to, for example, a cement kiln for use as fuel in high temperature material processing at a temperature of about 2600° F. with zero waste. The clean backing/fiber layer material may advantageously offset the use of fossil fuels that would otherwise be required to heat the cement kiln. The 8 inch minus product size of the clean backing/fiber layer is satisfactory for purposes of the cement kiln, and as noted above larger carpet backing/fiber layers and carpet rolls are beneficially not produced in the system 200 and inefficiencies and costs of recovering larger carpet pieces are advantageously avoided.

As indicated, shredding of the backing/fiber layer at this stage will typically make it easier to handle and avoid inefficiencies in having the backing/fiber layer maintained as a large roll. Maintaining the backing/fiber layer of the artificial turf as a large roll does allow this component to be reused in an alternative field installation later. However, the artificial turf product being reclaimed by the present systems and methods is typically being replaced precisely because it is near or at the end of its useful life. Often this is because of wear to the fiber materials. Thus, thebacking/fiber layer will typically not be particularly valuable for such reuse resulting in it having a dramatically decreased value and potential difficulty to use in such applications. Storage of large rolls for such limited potential reuse market also imposes its own costs for storage and the need to potentially dispose of unused product at a later time.

Utilizing the shredded backing/fiber layer material as a combustion input for a system such as a cement kiln allows for the backing/fiber layer material to be processed and returned to a valuable secondary use much faster than attempting to reclaim the component plastics of the backing/fiber layer material and avoids the storage issues of large rolls. The backing material and the fiber material are typically of different plastics and can be difficult, if not impossible, to recycle into alternative plastic objects unless they are separated and reclaimed individually. This is typically fairly complicated as the backing and fiber are attached to each other and expressly not designed for easy separation. While such separation and individual reclamation may be performed in an embodiment of the present systems, elimination of such steps can substantially reduce processing saving both time and resources.

As a combustion process input, the combination material can be used without further modification allowing for the combination to be used without the need for any additional processing. Further, in a high temperature combustion system such as a cement kiln, imperfect separation of the infill from the backing/fiber layer is also typically not concerning as any infill that remains with the shredded backing/fiber layer will typically not have any substantial effect on the combustibility. Infill remaining will either also be combusted or will present an easily removed and non-toxic residual. Thus, the screening equipment 220 need not obtain complete separation which can allow the screening step to be performed in less time.

The pre-screening described above may reduce the particle size considerably for further screening of the infill material/medium (e.g., crumb rubber and sand) in another phase of system operation to progressively process the infill material/medium to ultimately separate crumb rubber and sand using further equipment such as that described below. In some embodiments, however, the pre-screening described above may not be needed and could be considered optional in the system 200 when the infill material/medium can be successfully processed in the further equipment described below without prescreening it first. Combinations of the further equipment described below are likewise possible wherein different types of screeners are used in succession to achieve the ultimate separation of sand and crumb rubber.

Much of the desired level of separation of infill into component crumb rubber and sand will depend on the resultant use of the materials individually and in combination. In an embodiment, the crumb rubber and sand will both be reclaimed for reuse into a new artificial turf use. In an embodiment, this may even be in conjunction with the same field from which it was originally removed. In this arrangement, separation of the crumb rubber and sand (or other materials) may be wholly unnecessary and the combination could simply be cleaned and returned to use. Such reuse without separation, or with limited separation, may be particularly valuable in on-site or near-site mobile processing embodiments where there is also a reduced need to transport machinery to perform separation to the site. However, while non-separation and limited separation are viable options in some cases, in many cases an owner of a field which will use reclaimed sand and/or crumb rubber will want to specify desired ratios of sand to crumb rubber and specific size distributions of one or both to provide for a specific target performance. This could be, for example, if the infill from a temporarily earlier reclaimed turf application is to be used in a temporarily later artificial turf installation (such as to deal with the time of processing the materials from the earlier field). The two applications may have different performance requirements and require different ratios of materials. In this case, separation of the infill into constituents will typically be preferred as it would allow each component to be separately selected and sold. Separation also allows for the infill components to be reused for other applications.

As with the separation of infill from the backing/fiber layer, the separation may be imperfect. In particular, the separation may result in a substantially pure crumb rubber segment, a substantially pure sand segment, and a segment comprising a mix of the two. While the first two segments may be used anywhere that new product may be used, the later mixed segment may be treated differently. For example, the mix may undergo additional separation steps as is contemplated elsewhere herein so as to increase the total amount of both substantially pure fragments. Further, as the sand and crumb rubber particles in the third segment will typically be similar, separation may allow for an increase of particles of that size to be added to each substantially pure segment to alter its distribution. Alternatively, the mixed third segment may be sold as its own product or may be combined with one or both of the substantially pure products based on the desired end use of the resultant products to be purchased. For example, if the infill constituents were to be reused on the same field, a percentage of the unseparated mixed fraction may be added back to a blend of the two substantially pure fractions while still meeting desired performance characteristics.

Infill material separating equipment 230 in the system 200 processes the infill material/medium into its constituent materials (e.g., to separate sand and crumb rubber in the infill material/medium). In the equipment 230 this may be realized, for example, via a known two deck incline vibratory screener set up with a top harp screen deck of ¼″ and a lower harp screen deck of 1 mm to separate the sand from the crumb rubber. Mobile and non-mobile vibratory screen equipment is known and may be utilized, and in some cases vibratory screen equipment may be custom fabricated for the system 200.

In contemplated embodiments the infill material/medium may be screened to a 1 mm particle size that may effectively separate turf, fibers, crumb rubber, and sand under conditions wherein the shredded material is dry and the rubber material is not bonded to the sand. Conventional mobile screening equipment is not capable of mobile screening to a <1 mm cut, however, so modifications to include finer screens are needed in a mobile system 200. Additionally, moisture and/or bonding of the rubber to the sand may complicate the screening to a 1 mm particle size for the sand such that additional measures are advisable.

Screening to the 1 mm particle size for the purposes of the recycling system 200 may be successfully performed or enhanced by incorporating heat into the screening process. Heating the infill material will desirably reduce moisture content as well as assist with crumb rubber expansion to release bonds between the sand and crumb rubber. To facilitate such heating the screen box of the screening equipment may be partially or completely enclosed. In a contemplated example, heat may be applied with portable 1.5 MM BTU heaters, although other heat sources are possible. Particular heating equipment and details are described further below. The infill material is heated to a degree sufficient to release any moisture from the rubber material, but the heated material is maintained in a solid form without being fluidized.

Since the construction and operation of conventional vibratory screening machines are well-known they are not described in further detail herein. Such conventional machines may be modified with the needed screens and appropriate enclosures to facilitate heating of the material being screened. Custom-fabricated screening equipment with integrated heating features is likewise contemplated in other embodiments of the system 200.

Once the sand and crumb rubber are separated in the vibratory screener, they may be packaged into supersacks, and made available for the installer to reuse in the installation of the new reconstructed turf field with a replacement backing and fiber layer 120.

As contemplated previously, regardless of methodology used for separation, the separation of component materials of the infill need not be perfect and/or complete, and the products provided may include some mixing or blending of the infill materials.

Infill material separating equipment 230 for the system 200 may also include a known high frequency direct excitation screening machine capable of screening to a <1 mm particle size if appropriate screens are provided to effectively separate turf, fibers, crumb rubber, and sand utilizing up to 5 decks of separation under certain conditions. Such a screening machine is generally designed to process moisture prone material, but heat can be introduced to the screened material for the reasons discussed above. Beneficially, such a direct excitation screening machine is already enclosed and can be designed with a heat entry port as well as a filtered exhaust port to facilitate beneficial heating. Custom-fabricated mobile machinery having the desired direct excitation screening and heating features is possible. Likewise, non-mobile direct excitation screening equipment is possible, including but not limited to custom-fabricated stationary machinery.

Once the sand and crumb rubber are separated from a direct excitation screener, they may be packaged into supersacks and made available for the installer to reuse in the installation of the new turf field.

Infill material separating equipment 230 may also include a known flip flow screener machine which may be operable with 1 mm or smaller dual polyurethane screen mats and dual vibration principles to screen the infill material/medium to a 1 mm particle size wherein turf, fibers, crumb rubber, and sand may be effectively separated. This is the first time, however, 1 mm polyurethane screens would be used for this type of flip flow screening application. The flip flow technology is capable of processing small material prone to moisture as well as increasing the amount of time the particles are airborne. Optional heating to enhance the separation of materials would be realized by enclosing the screen box only, and using portable 1.5 MM BTU heaters to heat the enclosure. Since flip-flow screener machines are well-known, further description thereof is omitted.

Once the sand and crumb rubber are separated in a flip flow screener, they may be packaged into supersacks and made available for the installer to reuse in the installation of the new turf field.

The heating equipment 240 may include, for example, flameless heaters which will supply hot dry air to the infill separating equipment 230 such as that described above. The heating equipment 240 may provide, for example, 1.5-2 million BTU of heat to supply hot air at a high airflow volume or rate of 5,000 cubic feet per minute (CFM) at a temperature of 140° F.-180° F. in a contemplated example. Such hot air flow at a high rate in the screening area will dry the infill material when needed, as well as to expand the rubber to facilitate its separation from the sand in the screening by breaking bonds between the sand and crumb rubber. Higher temperature material processing (e.g., 250-300° F.) is beneficially avoided in the operation of the heating equipment 240 and lower operating costs for the system 200 are possible. Heat-related changes in density of rubber attributable to higher temperature processing of material is also beneficially avoided, which can undesirably affect system efficiency in the output load from the system 200. Specifically, higher temperature processing resulting in a reduced density of the rubber material will decrease the tonnage of rubber material output from the system 200 for re-use in the reconstructed turf surface. Changed rubber density may also negatively impact the performance and desirability of the rubber material in the reconstructed artificial turf system. The heating equipment therefore applies lower temperature air at a high airflow volume to avoid negative effects of higher temperature air at lower airflows that may be utilized in conventional artificial turf recycling systems and processes.

In contemplated embodiments, about 1000 cubic feet of screening area will need to be heated with the dry air. As such, the screen box of the screening equipment 230 may be enclosed (or be modified to become enclosed) and an infeed conveyor with a high temperature ceramic fiber insulated cover may be provided. A roll over cover may be supported by a tubular bow system mounted to the stationary frame of the screening equipment 230. Metal heat and ventilation ducts may also be provided on each side of the bow system framework. Such ductwork may include air directing fins inside and an outside port connection, for example, for a high temperature 16″ flex hose connected to the heater. Fitted ceramic insulated panels may be provided as needed to enclose open areas on the side of, and below the screen box of the screening equipment.

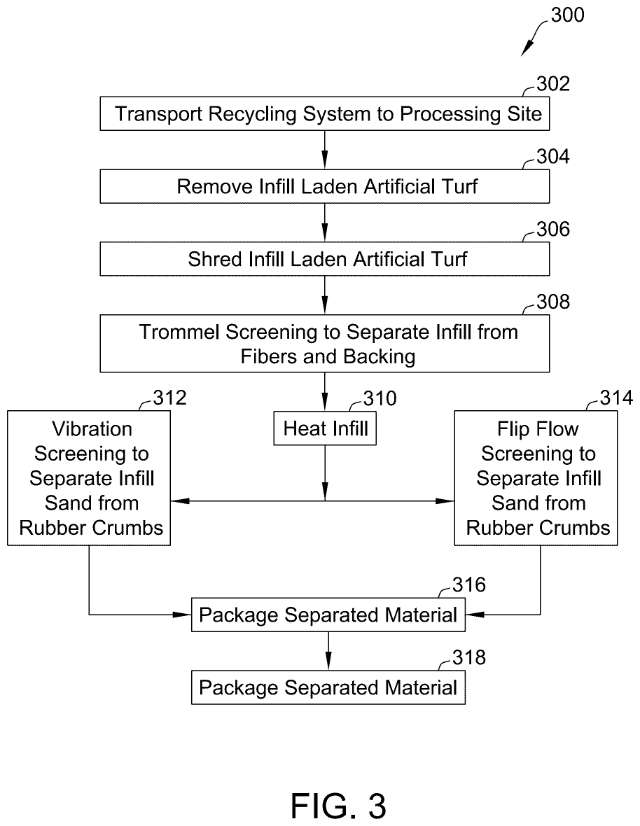

FIG. 3 is an exemplary flowchart of method processes 300 performed in the artificial turf recycling system 200 (FIG. 2).

At step 302, mobile equipment such as that described above is transported to a processing site at or near the turf surface/system 100 (FIG. 1) that needs replacement or to a hub location as described above. As such, the recycling system 200 (FIG. 1) is brought to or near the turf surface/system site, or at a reduced distance via the hub location than otherwise may be required to transport the turf materials for processing at a brick and mortar facility. As such, the remainder of the method processes 300 may be performed efficiently and at lower cost by avoiding transport of materials across farther distances. The equipment may be transported in any manner described above or below or otherwise known in the art. In a non-mobile system, step 302 is not performed and the equipment described above is instead located at a remote site such as a brick and mortar site where the equipment is generally fixed and non-movable and therefore non-mobile in the context of the present disclosure.

At step 304, infill laden artificial turf is cut and rolled to remove it from the turf system needing replacement. Step 304 may be performed using equipment such as that described above and may in some cases be performed by the installer of the replacement turf surface/system as a preparatory step to the performance of the remainder of the method processes 300. Alternatively, step 304 may be performed as part of the recycling system with appropriate equipment.

At step 306, rolled turf containing sand and crumb rubber infill from step 304 is shredded using equipment such as that described above.

At step 308, the shredded turf material is optionally pre-screened to separate the infill material/medium from the fiber/backing material. The pre-screening may be performed using any of the equipment described above or that is otherwise known in the art in a first phase of the infill material reclamation.

At step 310 heat is optionally provided to the shredded material from step 306 which may be pre-screened at step 308. The heat may be provided using any of the equipment described above (e.g., a trommel screener) or that is otherwise known in the art.

At step 312, the shredded material, which may optionally be pre-screened and heated per steps 308 and 310, is further processed in a vibratory screener such as that described above or otherwise known in the art in another phase of infill separation.

At step 314, the shredded material, which may optionally be pre-screened and heated per steps 308 and 310, is further processed in a flip flow screener such as that described above or otherwise known in the art in another phase of infill separation.

At either steps 312 and 314, screening to a 1 mm particle size as described above will separate the sand from the crumb rubber, while larger screens will separate the backing/fiber from the sand and crumb rubber, which may or may not be bonded per the discussion above depending on particular conditions at the site of the turf surface/system being replaced. When prescreening at step 308 is employed to remove the backing and fiber layer, the screening at steps 312 and 314 only separates the sand from the crumb rubber. It is recognized that while 1 mm screening is advantageous for the reasons described above, 1 mm screening is not strictly required and larger screening (i.e., greater than 1 mm screening) is therefore possible in further and/or alternative embodiments. The output sand and crumb rubber is sufficient to pass an applicable performance test for reuse in another artificial turf system.

At step 316, clean processed turf/carpet, sand, and crumb rubber which has been separated will be packaged. In a contemplated example, one or more of the separated materials may be loaded separately into nylon super sacks and as shown at step 318 may be transported to another location for recycling and reuse in the replacement turf surface/system installation or for other purposes such as cement kiln fuel. In a mobile recycling system, because the clean sand and crumb rubber is already at or near the site of the installation it is readily available for installers at significant cost savings relative to installations wherein the infill sand and rubber needs to be obtained and transported from another location at a greater distance from the installation site.

The inventive concepts described herein can be further adapted to separate additional and/or alternative constituents of infill material such as cork or elastomers for potential recycling and reuse with similar benefits to those described above. As such, the recycling system is not necessarily limited to inflow material/medium consisting of sand and crumb rubber per the foregoing examples.

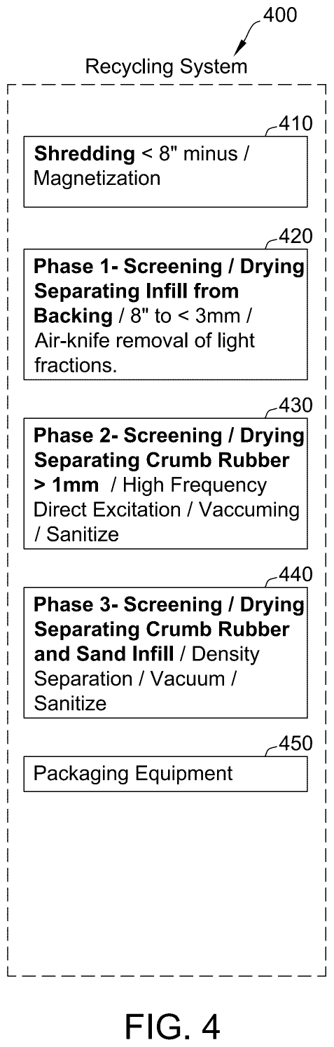

FIG. 4 is a block diagram of a second artificial turf recycling system 400 according to an embodiment of the present invention. The system 400 includes enhancements to the system 200 to further improve recycling and reclamation performance and overcome certain limitations of existing artificial turf recycling systems.

The system 400 includes shredding equipment 410 similar to the shredding equipment 210 described above to process rolled exhausted infill laden turf. The shredding equipment 410 is operable to output, for example, an 8 inch minus product as described above for further processing in the system 400. The shredding equipment 410 may also include magnetization features to remove any metal material in the rolled exhausted infill laden turf as it is being shredded. Removal of metal in the operation of the shredding equipment 410 may reduce potential complications in the rest of the equipment presented by large metal particles and improve system efficiency and performance.

The output 8 inch minus shredded product is input to screening and drying equipment 420 that is operative in a first phase of material reclamation processing wherein the 8 inch minus product is reduced to about a 3 mm minus product in a trommel screener. As used herein, a 3 mm minus product means that the largest particle size has a dimension that is no larger than about 3 mm. In this example, the equipment 420 reduces the size of the 8 inch (203 mm) minus shredded product by about 67 times in a single stage of the process, significantly more than conventional artificial turf recycling systems including initial downsizing of about 10 times in a first stage of recycling system operation that is followed by additional shredding, cutting and or screening steps to reduce the material size in a successive manner with additional equipment. The screening equipment 420 is operative to more simply and completely remove the infill material for further processing in a reduced amount of time relative to conventional systems and methods which include further processing of reduced size turf material to recover additional amounts of the infill material.

The 3 mm minus product is not required in all embodiments, however, and greater or lesser minus product sizes may be obtained instead as desired with the shredding equipment 420. Relatively speaking, the 3 mm minus product will facilitate a successful reclamation of the infill material using the rest of the equipment in the system 400 as described further below, but variations are possible with otherwise similar advantages and benefits.

In a contemplated example, the trommel screener of the equipment 420 includes, for example a 20 ft×5 ft drum with a rotating auger inside to convey the shredded material along an axis of the drum. The drum includes a 3 mm mesh surround allowing fine particles to pass through and preventing larger particles from passing through. The fine particles include sand and rubber which are effectively separated from the larger backing and fiber layer in the drum. Further, the trommel screen may be covered/encased with a ceramic blanketing and may be provided with airflow to dry and aerate the material passing through the drum. Clean turf is output from the drum.

The fine particles separated in the drum are further processed with an air knife in the equipment 420. The air knife removes light material (e.g., carpet fibers that have separated from the backing layer) from the fine sand and crumb particles which are heavier.

In a contemplated embodiment, the air knife may be implemented as a two part blower accepting an input such as a 6 inch to 15 inch air hose and outputting air to, for example, one or more nozzles having about 1 mm airflow outputs. The air knife is operable to realize positive and negative pressure to remove light material via blowing the light material upward from the fine sand and rubber particles and removing the light materials via suction at the negative pressure port(s). The positive pressure is sufficient to cause the light material to become weightless and therefore easily removable while the heavier sand and crumb particles will not be affected by the air knife.

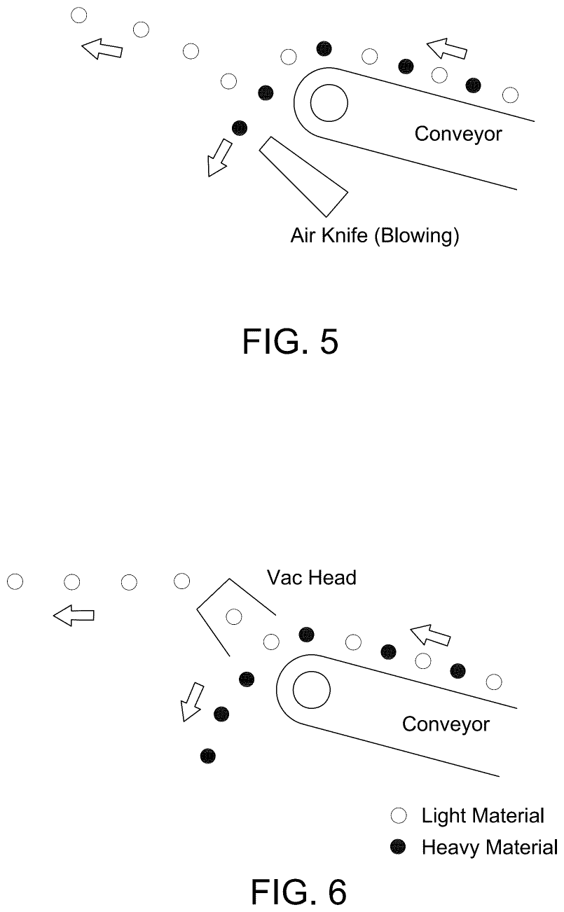

In a contemplated embodiment, the air knife is located at an end of a planar conveyor belt as shown in FIG. 5. The air knife receives the 3 mm minus product on the conveyor belt in the operation of the drum. The air knife may be oriented angularly with respect to a plane of the conveyor belt and blows air away from the conveyor belt at an end of thereof where the fine 3 mm minus product falls off of the belt. The airflow produced by the air knife renders the light material in the fine 3 mm minus product weightless so that the light material can be removed by suction whereas the heavier sand and crumb particles in the fine 3 mm minus product fall through the airflow of the air knife. The fine sand and rubber particles are therefore collected for further processing in the system via additional drying and screening equipment 420. A similar effect can be realized with directed airflow from the air knife at the end of the belt in another orientation at a different angle relative to the plane of the belt. All that is needed is that the heavier particles (i.e., sand and rubber) will fall through the airflow via gravitational force while the lighter particles are rendered weightless and do not fall but instead are removed via the negative pressure suction of the air knife.

In contemplated embodiments of the equipment 420, the conveyor belt as shown in FIG. 5 may be inclined such that the plane of the belt is not horizontal in operation. The drum in the equipment 420 may be inclined as well, although variants are possible wherein the drum and/or the conveyor belt are generally horizontal while the equipment 420 is operating. A vacuum may also be provided as shown in FIG. 6 to create or to enhance the suction and removal of the light particles in the fine 3 mm minus product carried on the belt. In certain contemplated embodiments the air knife and vacuum may be used in combination or may be utilized separately to remove the light materials such as detached carpet fibers.

The drying and screening equipment 430 is operable in a second phase of processing to further refine and reduce the fine 3 mm minus product output from the equipment 420 to about a 1 mm minus product size. As used herein, a 1 mm minus product means that the largest particle size has a dimension that is no larger than about 1 mm. The 1 mm minus product size is not required in all embodiments, however, and greater or lesser minus product sizes may be obtained instead as desired with the shredding equipment 430. Relatively speaking, the 1 mm minus product will facilitate a successful reclamation of the infill material using the rest of the equipment in the system 400 as described further below, but variations are possible with otherwise similar advantages and benefits.

The drying and screening equipment 430 for phase 2 may be a high frequency direct excitation screener similar to the one screener referenced above. Recirculating warm air is introduced at a sufficiently high pressure to eliminate moisture in the material being processed and to more effectively separate sand particles from the rubber crumb particles. As described herein, warm air shall mean low heat to realize a temperature such as 110°-120° F. Further, “low heat” as described herein is specifically distinguished from “high heat” (e.g. 250°-300° F.) that can change a density of the rubber particles and negatively impact reclamation of the system per the discussion above. In some embodiments, recirculating ambient air is possible, provided that it is sufficiently warm (e.g., 85°-95° F.), to eliminate moisture in the processing of the material without “adding heat” in the operation of the system 400.

In various different embodiments, the direct excitation screener may include a vibrating table, a vibrating frame, or a vibrating cloth that is operative to reduce the input 3 mm minus product to a 1 mm minus product.

Negative pressure may be applied in the screening equipment 430 to remove any residual material that is neither sand nor rubber crumb. Vacuuming of the material, in combination with the recirculating warm air, produces a cleaned and sanitized output of sand and crumb rubber. The output sand and crumb rubber is sufficient to pass an applicable performance test for reuse in another artificial turf system.

A roller magnet may also be provided on an end of a conveyor belt collecting the 1 mm minus product in the operation of the screening and drying equipment 430. The roller magnet is operable to hold metal material on the belt while the non-metal material (e.g., rubber and sand) falls off the belt as it passes around the roller magnet. The metal material is held to the belt around and underneath the magnetic roller, however, such that the sand and rubber is separated from the metal material. As the belt progresses past the roller, the magnetic attraction to the metal is weakened and eventually the metal falls off the belt at a location spaced from where the sand and rubber crumb fall off of the belt. The sand and rubber in the 1 mm minus product size may therefore be collected and output by the screening equipment 430 while separately collecting and outputting metallic material. The conveyor belt in the equipment 430 may be inclined or may be horizontal in the operation of the equipment 430.

The 1 mm minus product size output from the equipment 430 may then be input into further screening and drying equipment 440 wherein the 1 mm minus product is further refined and reduced to a 0.5 mm minus product in a phase 3 operation of the system. As used herein, a 0.5 mm minus product means that the largest particle size has a dimension that is no larger than about 0.5 mm. The 0.5 mm minus product size is not required in all embodiments, however, and greater or lesser minus product sizes may be obtained instead as desired with the equipment 440. Relatively speaking, the 0.5 mm minus product will facilitate a successful separation and reclamation of the infill material constituents, but variations are possible with otherwise similar advantages and benefits.

In a contemplated example, the equipment 440 includes one or more density tables operable to blow air from below the sand/crumb 1 mm minus product to fluidize the mixture and further screen the material via a vibrating screen. Sand may be separated from the rubber by particle size and any material that is not sand or rubber in the 1 mm particle size may also be separated. The equipment 440 therefore outputs clean sand, clean rubber, and dirt/waste material. The clean sand and rubber can be reused in a replacement turf system while the dirt/waste material can be disregarded.

In a contemplated system, four inline density tables of the equipment 440 are fed by a single machine of the equipment 430 to reduce processing time and improve efficiency of the system 400.

Any of the outputs from the equipment 440 or the other equipment described (e.g., the carpet fibers, backing layer, metallic material, etc.) may be packaged by the packaging equipment 450 and made available for reuse and recycling.

The reclaimed crumb rubber at the conclusion of the system processing will be “light” versus the amount of crumb rubber used in the original artificial turf surface installation. Some additional crumb will therefore be needed to construct the replacement turf surface. A light layer of new crumb is typically sufficient to close the gap between the reclaimed rubber crumb and the rubber crumb needed to complete the replacement turf system. The light layer of new crumb is sometimes referred to as a “top dress” to complete the installation of the replacement turf. Because of the top dress, the reclaimed rubber crumb need only be functional. It need not be completely purified, completely sanitized, or beautiful in appearance. Some discoloration or impurity is tolerable since the reclaimed rubber crumb will not be visible in the replacement turf system. The same is true for the reclaimed sand which likewise is not visible in the replacement turf system and therefore need be functional but not beautiful and therefore not require the same purity as some conventional processes provide with extended processing time and cost to produce. The system 400 beneficially balances material processing speed and functionality of separated infill material from the carpet/turf to optimize processing time and cost while avoiding over-processing of materials that do not enhance the performance or appearance of replacement turf systems.

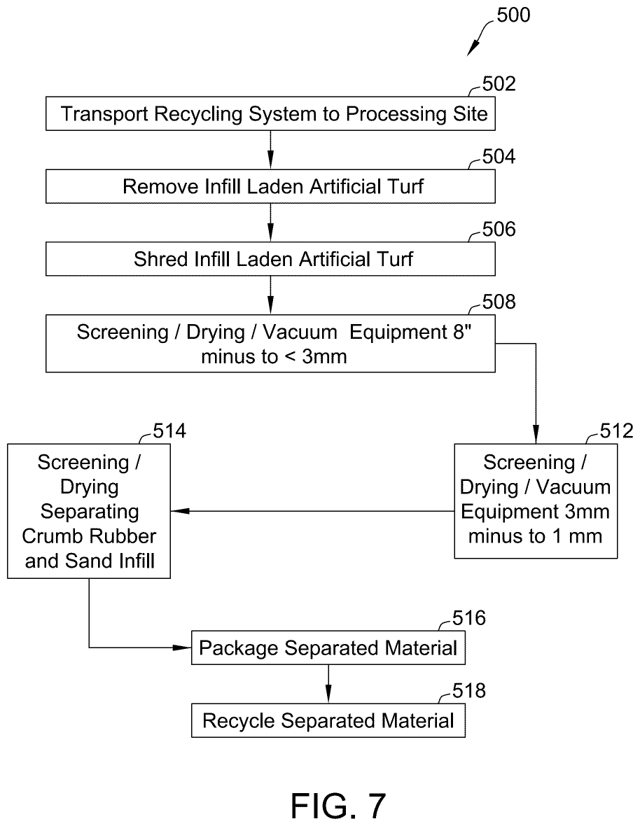

FIG. 7 is an exemplary flowchart of method processes 500 performed in the artificial turf recycling system 400 (FIG. 4).

At step 502, mobile equipment such as that described above is transported to a processing site at or near the turf surface/system 100 (FIG. 1) that needs replacement or to a hub location. As such, the recycling system 400 (FIG. 4) is brought to or near the turf surface/system site, or at a reduced distance from the turf surface/system site at a hub location, so that the remainder of the method processes 500 may be performed efficiently and at lower cost by avoiding transport of materials across farther distances. The equipment may be transported in any manner described above or below or otherwise known in the art. In a non-mobile system, step 502 is not performed and the equipment described above is instead located at a remote site that is non-mobile such as a brick and mortar site.

At step 504, infill laden artificial turf is cut and rolled to remove it from the turf system needing replacement. Step 504 may be performed using equipment such as that described above and may in some cases be performed by the installer of the replacement turf surface/system as a preparatory step to the performance of the remainder of the method processes 500. Alternatively, step 504 may be performed as part of the recycling system with appropriate equipment.

At step 506, rolled turf containing sand and crumb rubber infill from step 504 is shredded using equipment such as that described above for equipment 410. Step 506 reduces the rolled turf to a relatively small initial minus product (e.g., 8 inch minus product) allowing the rest of the method to be successfully performed. As noted above, however, the relatively small 8 inch minus size is considerably larger than shredded material in certain types of conventional turf recycling processes, such that the shredding in the process 500 can be performed more quickly and at lower cost while still realizing the desired material reclamation for installation of a replacement turf system.

At step 508, the shredded turf material output at step 506 is screened at phase 1 to separate the infill material/medium from the fiber/backing material. The phase 1 screening may be performed using the equipment 420 described above or other suitable equipment in the first phase of the infill material reclamation. Step 508 applies a first type of screening which outputs infill material at a smaller minus product (e.g., 3 mm minus product) allowing the rest of the method to be successfully performed to complete reclamation of the infill material constituents. Step 508 outputs fiber/backing material which may serve as an alternative fuel for a cement kiln and infill which can further separated into its constituent materials for use in another artificial turf system.

At step 512, the screened infill material output from step 508 is screened at phase 2 to further refine the infill material/medium using the equipment 420 described above or other suitable equipment in the second phase of the infill material reclamation. Phase 2 at step 512 provides a second type of screening different from the first type at step 510 which outputs infill material at a smaller minus product (e.g., 1 mm minus product) allowing the rest of the method to be successfully performed to complete reclamation of the infill material constituents.

At step 514, the screened material output from step 512 is screened at phase 3 to further refine the infill material/medium using the equipment 430 described above or other suitable equipment in the third phase of the infill material reclamation. Phase 3 at step 514 provides a third type of screening different from the first type at step 510 and the second type at step 512 which outputs infill material at a smaller minus product (e.g., 0.5 mm minus product) to obtain separated infill constituents of sand particles and crumb rubber particles. The resultant particles sizes of the separated reclaimed constituents may be utilized in a reconstructed artificial turf surface while meeting industry standards of attractiveness and cushioning performance.

At step 516, clean processed turf, sand, and crumb rubber which has been separated will be packaged. In the context of the present disclosure, the clean materials may respectively be up to 99% by weight of only carpet/turf or carpet fibers, only sand, and only rubber that may perform satisfactorily for the reuses described herein. In a contemplated example, one or more of the separated materials may be loaded separately into nylon super sacks and as shown at step 518 may be transported to another location for recycling and reuse in the replacement turf surface/system installation or for other purposes. In a mobile recycling system, because the clean sand and crumb rubber is already at or near the site of the installation it is readily available for installers at significant cost savings relative to installations wherein the infill sand and rubber needs to be obtained and transported from another location at a greater distance from the installation site.

The inventive concepts described herein can be further adapted to separate additional and/or alternative constituents of infill material such as cork or elastomers for potential recycling and reuse with similar benefits to those described above. As such, the recycling system is not necessarily limited to inflow material/medium consisting of sand and crumb rubber per the foregoing examples.

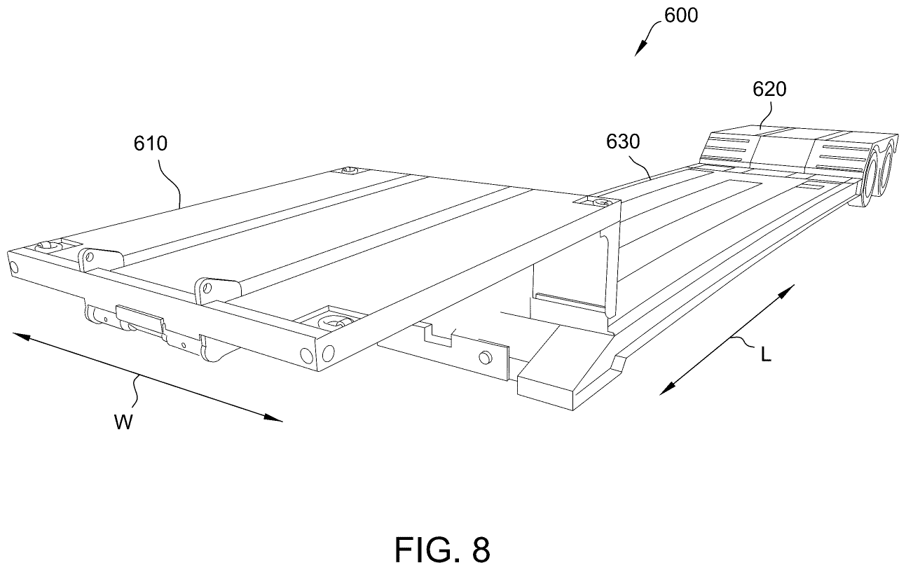

In some contemplated embodiments, the system 400 and method 500 may be implemented at least in part in a mobile apparatus such as that shown FIGS. 8-15. More specifically, some of the equipment in the system 400 may be arranged in a truck and trailer system that is operationally interconnected with self-propelled machinery that is operative proximate a site of exhausted artificial turf that needs replacement or at a designated hub location.

FIG. 8 is a first perspective view of a mobile apparatus 600 configured as a semi-trailer which may be pulled behind a semi-truck for locating the trailer at the processing site.

In the example shown, the semi-trailer apparatus 600 includes a first deck 610 on a first end where the trailer couples to the semi-truck, a second deck 620 opposite the first deck on a wheeled end of the trailer, and an intermediate deck 630 in between the first deck 610 and the second deck 620. The first, second and intermediate decks 610, 620, 630 each extend at a generally planar orientation that is spaced apart and parallel to the other decks. The first deck 610 has a first length, the second deck 620 has a second length, and the intermediate deck 630 has a third length which are all respectively different from one another. As such, equipment for the system 400 may be located at respectively different heights from the ground on the respective differently sized decks 610, 620 and 630 of the trailer.

In the configuration shown in FIG. 8, the trailer is in a compact transport configuration in which the overall length L measured along a longitudinal axis of the trailer and width W of the trailer measured along a lateral axis perpendicular to the longitudinal axis each respectively correspond to a typical length and width of trailers for road use. For example, in the compact transport configuration shown, the overall length of the trailer is about 53 ft, the most common length for freight transport semi-trailers in North America. The width of the trailer is about 8.5 feet or 102 inches, the standard width of semi-trailers in the North American market.

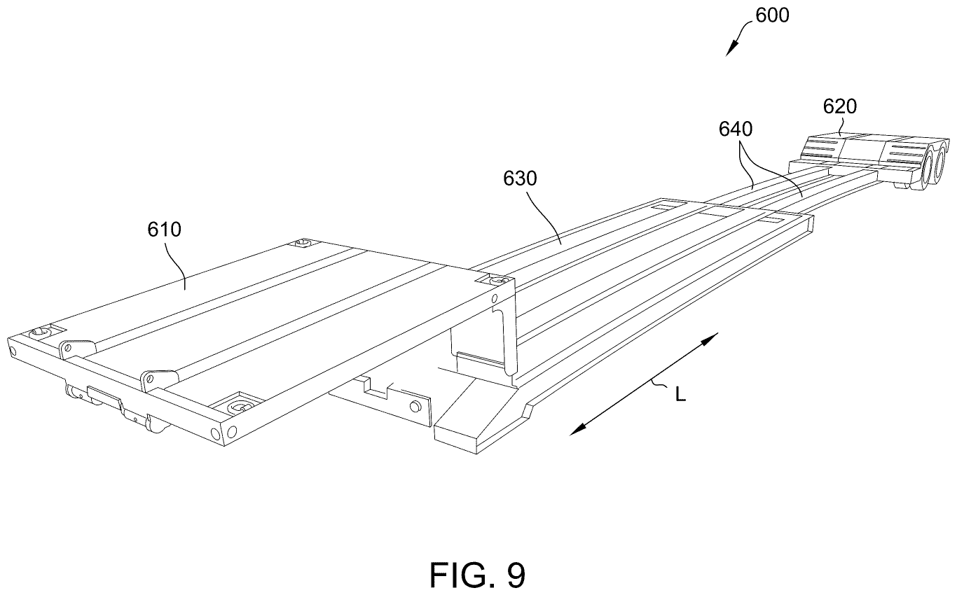

FIG. 9 is a second perspective view of the mobile apparatus 600 in an extended operational position configuration for use of the system 400 on an artificial turf recycling and reclamation site. Relative to the compact configuration shown in FIG. 8, the second deck 620 is separated from the intermediate deck by telescoping members 640 to extend the length L of the trailer without changing the width W of the trailer. An additional decking may be placed on the telescoping members 640 if desired to provide additional deck space to locate equipment of the system 400 on the trailer on the extended length. In another embodiment, equipment of the system 400 may be mounted to the telescoping members in the absence of additional decking. After the system 400 has operated to process all of the exhausted artificial turf material, system equipment may be removed from the trailer, and the telescoping members 640 may be retracted to reconfigure the trailer in the compact transport configuration shown in FIG. 8. The compact configuration is sometimes referred to as a collapsed configuration of the apparatus 600 for road transport.

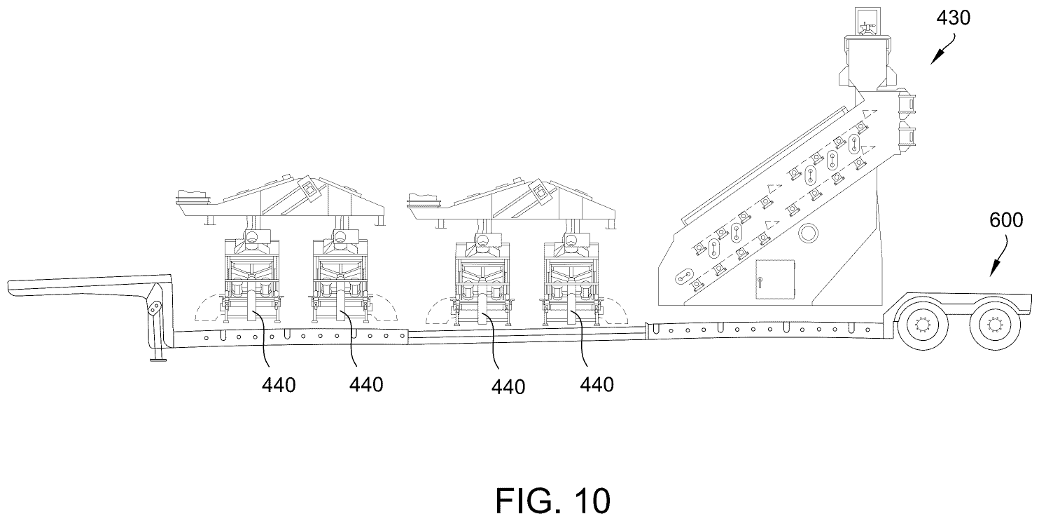

FIG. 10 is a side elevational view of the apparatus 600 shown in FIG. 9 with operative recycling and reclamation equipment of the system 400 located thereon. In the illustrated example, the equipment 430 is located on the rear of the extended trailer while four machines 440 are also located on the trailer, with the equipment 430 feeding the four machines 440 as described above. Folding conveyors such as those described below may be provided to move material away from the trailer and between the equipment 430 and the machines 440.

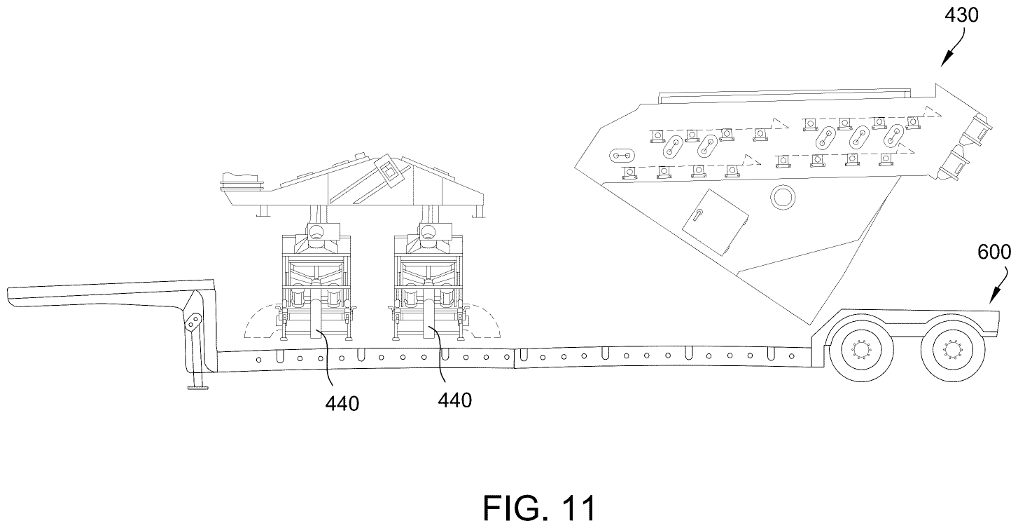

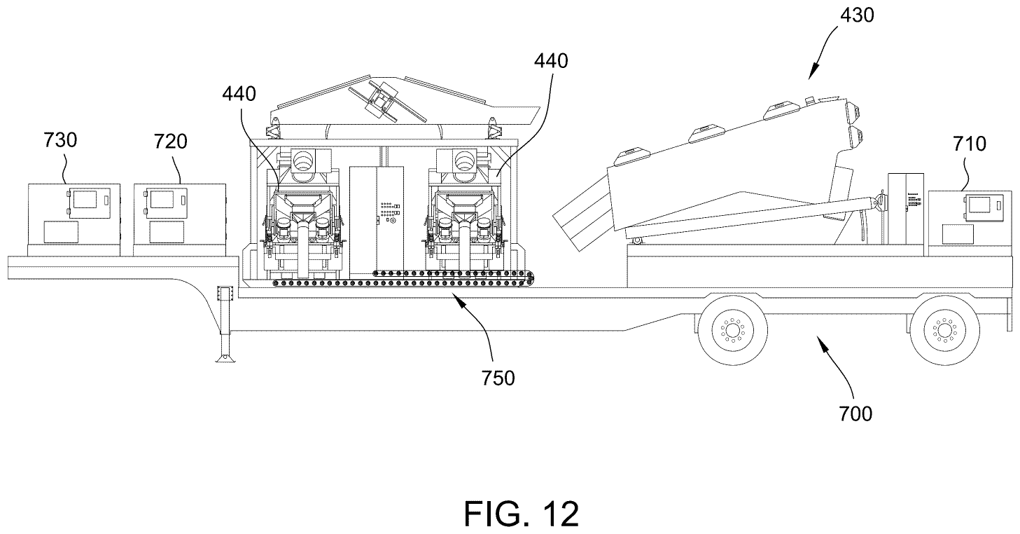

In the operating position shown in FIG. 10, the equipment 430 in has an overall height of more than 20 ft from the ground, while the machines 430 and feeding structure located above the machines are well below a height of 13.5 ft from the ground. Since 13.5 ft is the height or a standard semi-truck, it is desirable to transport the equipment on the trailer at a height less than or equal to 13.5 ft. As such, and as shown in FIG. 11 the equipment 430 may be rotated about a hinged connection to the trailer to a transport position with a reduced height at or below 13.5 ft. In the transport position, the inclined upper edge of the equipment 430 in the operating position (FIG. 10) is oriented to extend generally horizontally and parallel to the decks of the trailer, while the planar lower edge of the equipment in the transport position (FIG. 11) is oriented to extend obliquely to the decks of the trailer. One or more hydraulic ram actuators may be provided to rotate the equipment 640 between the transport position (FIG. 11) and the operating position (FIG. 10). One or more transport legs may also be provided to stabilize the equipment 430 in the transport position for actual transit.

As also shown in FIG. 11, two of the four machines 440 (FIG. 10) are removed and the trailer is collapsed to the compact configuration, while the remaining two machines 440 are permanently mounted to the trailer and remain in place in the compact transport configuration shown in FIG. 11. As such, when the trailer is brought to the processing site in the compact configuration shown in FIG. 11, the trailer is extended and the two machines 440 are added to the trailer to assume the operational configuration. When the machine 430 is rotated back to the operating position, it may feed material to all four machines 440.

FIG. 12 is a left-hand view of an exemplary trailer apparatus 700 for the artificial turf recycling systems of FIGS. 2 and 4 and showing the apparatus in a compact transport configuration. The trailer apparatus 700 is similar to the trailer apparatus 600 and is shown in FIG. 12 with the equipment 430 in the transport position and first generator 710 for powering the equipment 430. Two machines 440 are mounted on the trailer apparatus 700 downstream from the equipment 430, and the machines 440 are powered be a second generator 720 on the apparatus 700. A heater 730 is also provided for use in the systems and methods described herein.

The trailer apparatus 700 further includes a conveyor belt 750 extending along the left side of the trailer. The conveyor belt 750 is shown in a compact transport configuration wherein a portion of the conveyor belt is folded over itself to reduce the longitudinal length of the conveyor belt for transport when the trailer apparatus is retracted or collapsed. In the transport configuration shown in FIG. 12, the folded conveyor belt 750 extends fully across the side of the two machines 440.

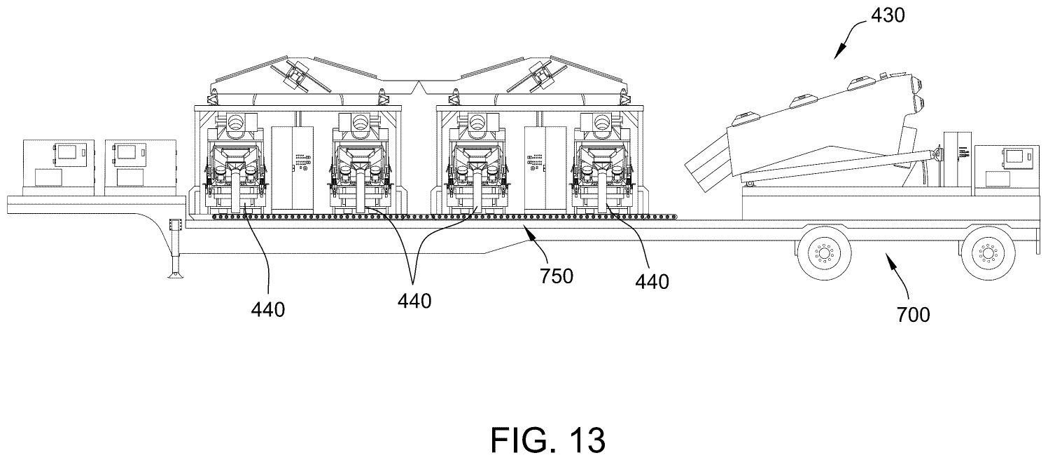

FIG. 13 is a left-hand view of the exemplary trailer apparatus 700 in an operating configuration wherein two additional machines 440 are added on the expanded trailer. The conveyor belt 750 is unfolded and extends with an increased length alongside all four of the machines 440. The equipment 430 may be rotated to its operation position to perform the methods described herein. The conveyor belt 750 is operable as a discharge belt for clean rubber or sand output from the machines 440.

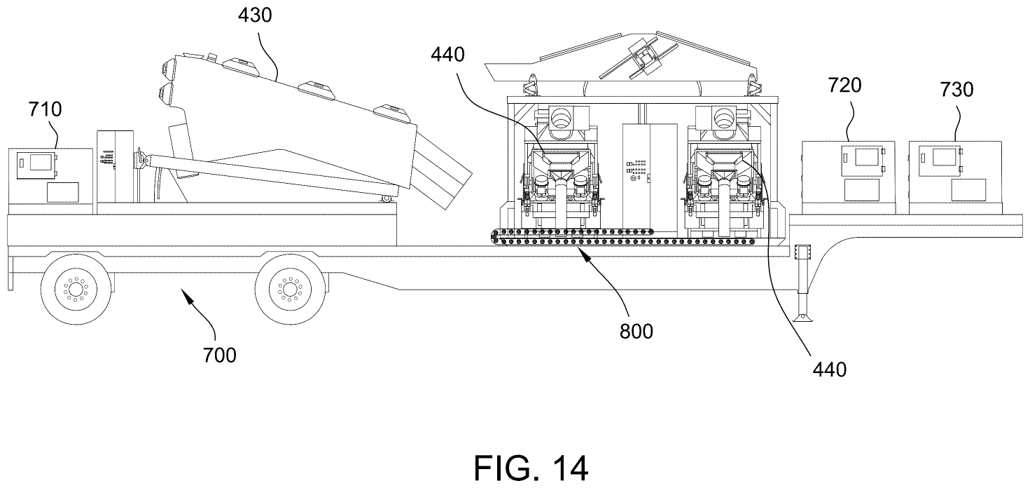

FIG. 14 is a right-hand view of the exemplary trailer apparatus 700 shown in FIG. 12. The trailer apparatus 700 includes a conveyor belt 800 extending along the left side of the trailer. The conveyor belt 800 is shown in a compact transport configuration wherein a portion of the conveyor belt is folded over itself to reduce the longitudinal length of the conveyor belt for transport when the trailer apparatus is retracted or collapsed. In the transport configuration shown in FIG. 14, the folded conveyor belt 850 extends fully across the side of the two machines 440.

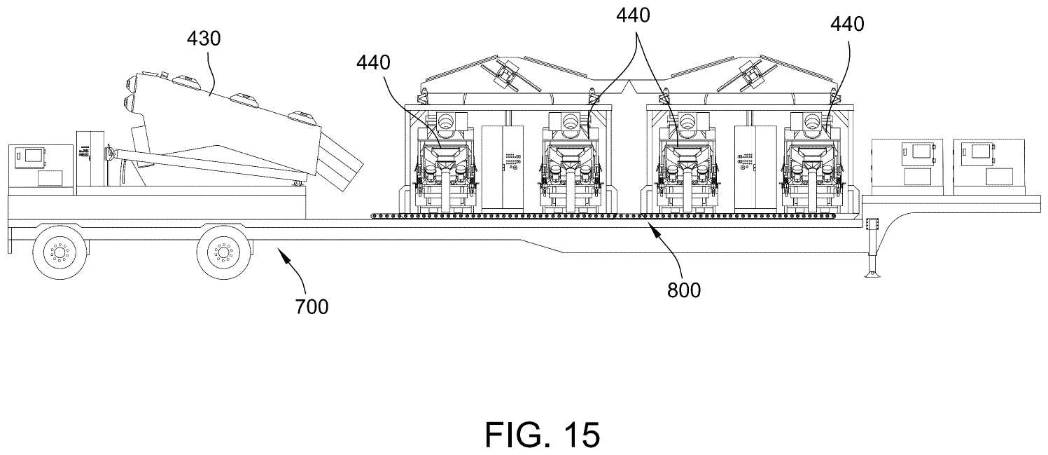

FIG. 15 a right-hand view of an exemplary trailer apparatus 700 in an operating configuration wherein two additional machines 440 are added on the expanded trailer. The conveyor belt 800 is unfolded and extends with an increased length alongside all four of the machines 440. The equipment 430 may be rotated to its operation position to perform the methods described herein. The conveyor belt 800 is operable as a discharge belt for clean rubber or sand output from the machines 440. In use of the apparatus 700 to perform the methods described, one of the conveyor belts 750 and 800 collects sand output from the machines 400 and the other collects crumb rubber.

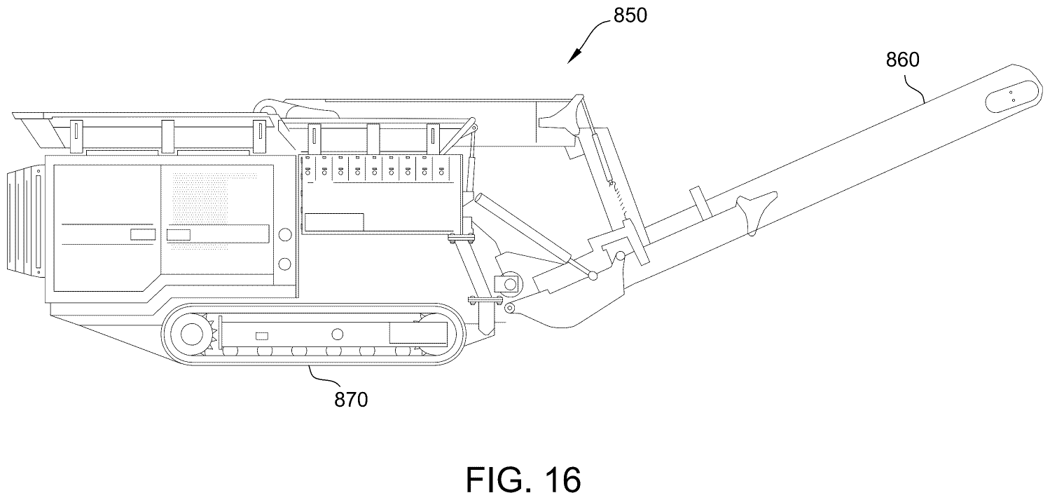

FIG. 16 is a side elevational view of an exemplary shredder machine 850 for the systems and methods described above and for use with the mobile apparatus shown in FIGS. 8-15. The shredder machine 850 includes a foldable conveyor belt 860 to reduce the size of the machine 850 for transport on a trailer apparatus such as that described above. The shredder machine 850 also includes a continuous tread or track system 870 for propelling the machine 850 along a surface of the ground under its own power, or to load and unload the machine 850 to and from a trailer. Once the shredder machine 850 is located at the processing site, it may shred exhausted turf rolls as described above and provide the shredded input at the desired minus product size as an input to perform the remainder of the methods.

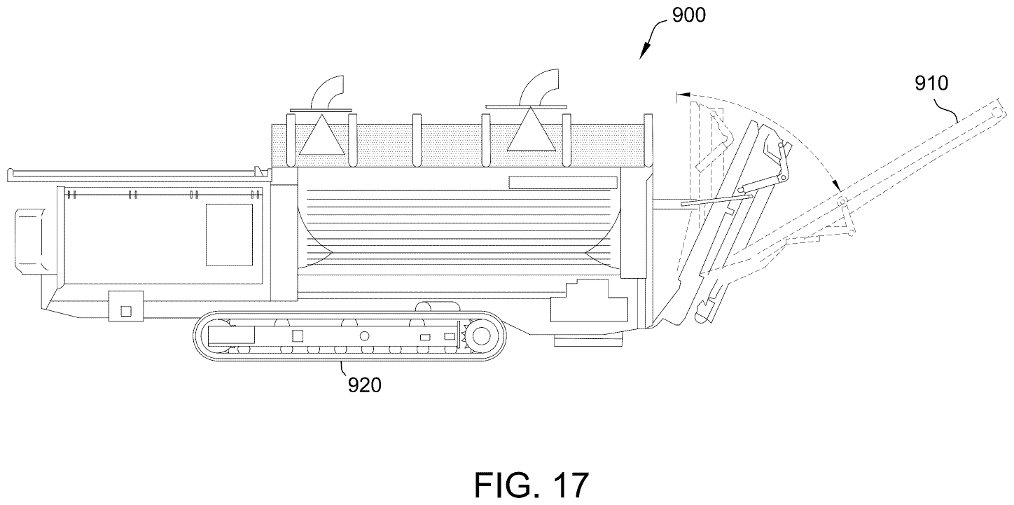

FIG. 17 is a side elevational view of an exemplary trommel screener machine 900 for the systems and methods described above and for use with the mobile apparatus shown in FIGS. 8-16.

The trommel screener machine 900 includes a foldable conveyor belt 910 to reduce the size of the machine 900 for transport on a trailer apparatus such as that described above. The trommel screener machine 900 also includes a continuous tread or track system 920 for propelling the machine 900 along a surface of the ground under its own power, or to load and unload the machine 900 to and from a trailer. Once the trommel screener machine 900 is located at the processing site, it may screen the shredded turf material as described above and provided a separated infill material input the equipment 430 on the trailer apparatus 600 or 700. The trommel screener machine 900 may operate on the ground behind the trailer apparatus 600 or 700 and feed the infill material to the equipment 430. The shredder machine 850 (FIG. 16) may likewise operate on the ground and feed the shredded turf material to the trommel screener machine 900. Both of the machines 850 and 900 may be brought to the processing site on a trailer.

By virtue of the apparatus 600 and 700, the method 500 may accordingly include the steps of configuring the apparatus 600 or 700 for transport, transporting the apparatus to the processing site, extending the trailer at the processing site, adding equipment to the trailer for operation of the system, unfolded the conveyor belts from the transport position to the operating position, rotating equipment from the transport position to the operating position and establishing feeding of outputs from the shredder and trommel screen machines to the machines on the apparatus 600 and 700. Once the infill constituents are reclaimed, the method 500 may further include steps of removing equipment so that the compact configuration can be re-established, rotating equipment from the operating position to the transport position, folding the conveyor belts for transport, and collapsing the trailer for transport.

While shown and described above the shredder and trommel screener machines are self-propelled and are operative on the ground next to the trailer apparatus 600 or 700, a similar trailer apparatus 600 or 700 may also include shredding equipment 410 and the phase 1 equipment 420 of the system 400. As such, one trailer may include the equipment 410 and 420 while another trailer may include the equipment 430 and 440 as shown in FIGS. 8 and 9. The trailers may be arranged such that the output from the equipment 420 on the first trailer may be fed to the equipment 430 on the second trailer. The method 500 may include steps of interconnecting the outputs and inputs in each trailer with or without additional equipment to make the interconnections.

The apparatus 600 or 700 may likewise be utilized with equipment of the system 200 described above with similar benefits and advantages to transport the equipment to and from a processing site for lower cost operation with a relatively easy set up and take down for system operation and transport.

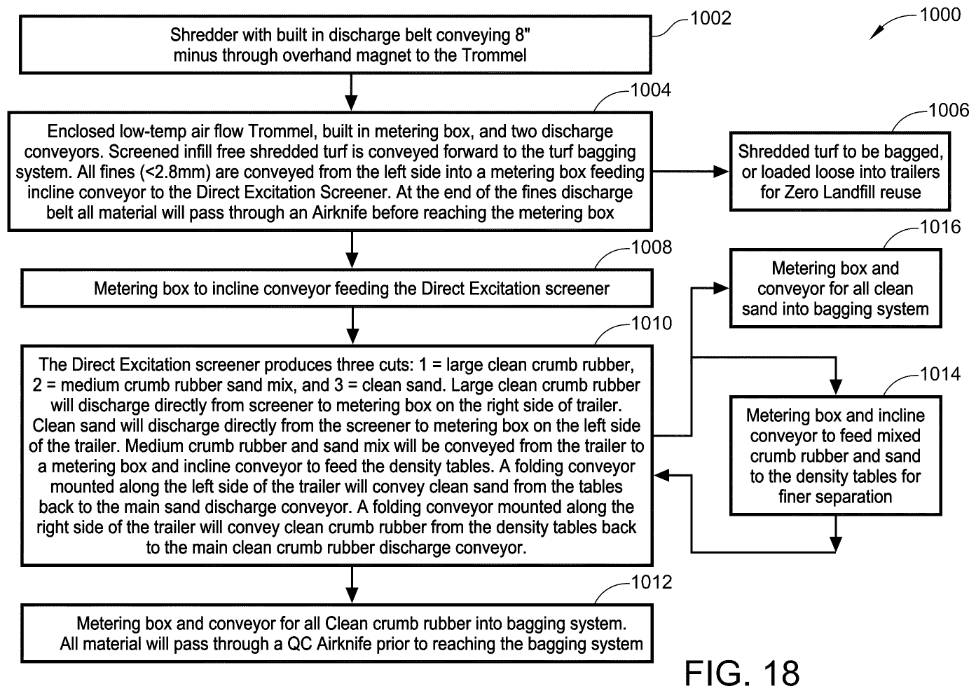

FIG. 18 schematically illustrates material flow 1000 in the operation of artificial turf recycling systems and processes such as those described above.

As shown in FIG. 18 at portion 1002, shredded material is conveyed on a built-in discharge belt of a shredder machine in the 8 inch minus product size to the trommel screener. The material passes on the discharge belt by an overhead magnet that operates to remove metal material from the 8 inch product size.

At portion 1004, the enclosed trommel screener includes a built-in metering box to accept the 8 inch minus shredded product and two discharge conveyors. The first discharge conveyors conveys the separated baking/fiber layer material forward to a turf/carpet baggage system as shown at portion 1006. Alternatively, the separated backing/fiber layer may be loaded in a loose or non-packaged form onto a trailer for transport to a cement kiln or for other beneficial re-use.

The second discharge conveyor of the trommel screener conveys fine separated infill material in about a 3 mm minus product size into a metering box that feeds an inclined conveyor of the direct excitation screener at portion 1008. The fine separated infill material passes through the air knife at the end of the second discharge belt before reaching the metering box at portion 1008. From the metering box, the remaining fine separated infill material enters the direct excitation screener at portion 1010. Large clean crumb rubber will discharge directly from the screener at portion 1012 to another metering box on the left side of the trailer apparatus. Medium sized crumb rubber and sand mix will be conveyed to another metering box at portion 1014 which inputs to the density tables for further separation of the sand and crumb rubber. A folding conveyor mounted along the left side of the trailer apparatus conveys clean sand from the density tables back to a main discharge sand conveyor at step 1016. Another folding conveyor is mounted along the right side of the trail apparatus to convey clean crumb rubber from the tables back to the main clean rubber discharge conveyor at portion 1012.

The clean rubber enters another metering box for bagging of the clean crumb rubber. The clean rubber material passes through a second air knife before reaching the bagging system wherein any residual light particles (e.g., detached carpet fibers) are removed before the rubber crumb is bagged in portion 1012.

The clean sand likewise enters another metering box feeding a conveyor for bagging the clean sand in portion 1016.

Another metering box is provided which accepts the medium sized crumb rubber and sand mix for re-introduction back into the screener so that the rubber and crumb may be further processed and separated into clean sand and clean rubber in potion 1014.

The conveyors and metering boxes such as those described above may be integrated into the machinery and/or integrated into the trailer apparatus including the machinery. The foldable discharge conveyors may be folded to compact transport configurations and unfolded for operation once the trailer apparatus is located at the processing site.

In contemplated embodiments the shredder equipment and trommel screener may be provided on a different mobile apparatus than the direct excitation screener and the density tables. Alternatively, the shredder equipment and trommel screener may not be mounted to a trailer apparatus but can be positioned in-line with one another and with the trailer apparatus to effect the material flow shown and described. Variations are possible concerning the flow of materials between and within each of the various types of equipment provided in the system. Finally, while mobile equipment and apparatus has been described, the material flow described in the system may be implemented in equipment that is not mobile in some embodiments. As such, the material flow may be realized in a permanently located and therefore brick and mortar facility while still realizing at least some of the benefits described herein.

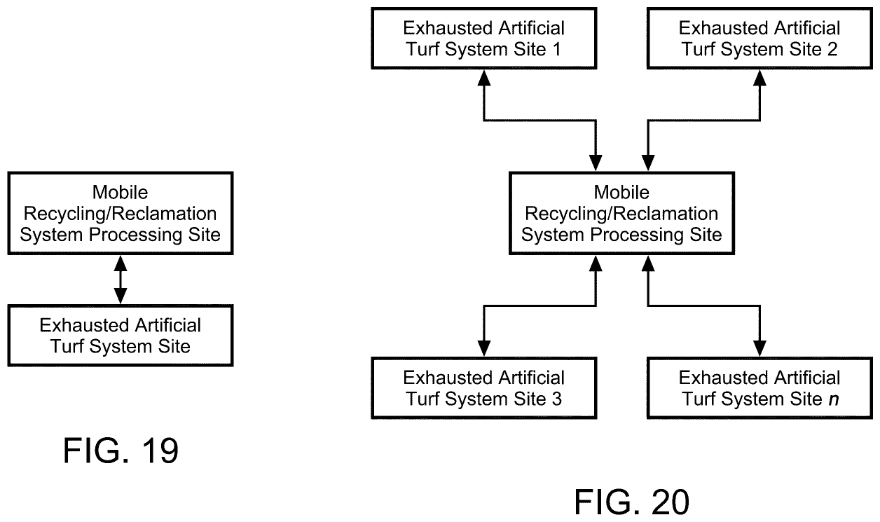

FIG. 19 schematically illustrates a first processing site arrangement for the systems and methods described above. The recycling and reclamation system is shown proximate or adjacent to the site of the exhausted artificial turf system. In such an arrangement, transport of rolled turf material is minimized, and so is the transport of reclaimed rubber and sand back to the turf system site for the installation of a replacement turf system. For example, the processing site may be just outside the site of the turf system such as in a parking lot or another area closely adjacent to the site of the exhausted turf and the replacement turf. The arrangement of FIG. 19 shows the optimal location of the material processing site with respect to a particular site of turf needing removal and replacement.

FIG. 20 schematically illustrates a second processing site arrangement for the systems and methods described above. The recycling and reclamation system is shown at a site that serves as a hub for a number of exhausted artificial turf system sites at different locations shown as Site 1, Site 2, Site 3 to Site n, wherein n is any integer greater than four. In such an arrangement, transport of rolled turf material is limited to a more optimal location between the various sites, and so is the transport of reclaimed rubber and sand back to the turf system sites for the installation of a replacement turf system. The hub arrangement of FIG. 20 balances the locations of multiple turf system sites to reduce transport of materials across the number of sites relative to a permanently located, brick and mortar facility located farther away than the hub location that otherwise would be required. The hub arrangement advantageously allows a single transport of the system to the hub location while beneficially serving multiple turf system sites. Once the turf system sites are served the mobile system may be beneficially moved to another hub location to serve another number of turf system sites at other locations.

The mobile systems and machinery described above may advantageously be transported to the processing sites shown in FIGS. 19 and 20 using a small number of trailers and equipment to rapidly provide the turf infill reclamation and recycling at low cost with reduced complexity relative to certain types of conventional artificial turf recycling systems and methods. Similar benefits would apply to non-mobile systems that happen to be relatively close to one or more artificial turf system sites or that serve as a desirable hub location for multiple turf system sites, and as such the systems and methods of the invention may be implemented in a non-mobile manner while otherwise realizing similar benefits.

The benefits of the inventive concepts described herein are now believed to have been amply illustrated in relation to the exemplary embodiments disclosed.

An embodiment of a material reclamation system for artificial turf including a backing and fiber layer and infill material has been disclosed. The system includes trommel screening equipment accepting shredded pieces of removed artificial turf including the backing and fiber layer and the infill material in a first shredded product minus size, the trommel screening equipment operable in a single stage to separate the infill material from the backing and fiber layer and output the separated infill material in a second product minus size including a mix of sand and crumb rubber. The system also includes infill screening equipment accepting the mix of sand and crumb rubber from the single stage in the second product minus size and operable to separate the mix of sand and crumb rubber into clean crumb rubber and clean sand.

Optionally, the second product minus size may be about 21 times to about 37 times less than the first minus product size. The second product minus size may also be about 67 times less than the first minus product size. The first product minus size may be about 8 inches (203 mm). The second product minus size may be about 3 mm.

As further options, the infill screening equipment may include a direct excitation screener operable to screen the mix of sand and crumb rubber to a 1 mm particle size to separate the crumb rubber and sand under conditions wherein the shredded pieces of removed artificial turf are dry and the crumb rubber is not bonded to the sand. The infill screening equipment may also include a density table operable to separate particles having a minus product size of less than about 0.5 mm.

Also optionally, the infill screening equipment applies low heat and high airflow volume to enhance a separation of the crumb rubber and sand. The applied low heat may be in a range of about 140° to about 180° F., in a range of about 110° to about 120° F., or in a range of about 85° to about 95° F.

The system may include at least one air knife operable to remove detached fibers from the mix of crumb rubber and sand. The system is a mobile system. The mobile system may include an expandable trailer apparatus. The expandable trailer apparatus may include at least one machine that is rotatably mounted on the expandable trailer apparatus and is rotatably positionable between a transport position and an operating position. The transport position for the at least one machine has a height of about 13.5 ft or less, and in the operating position the machine has a height greater than 13.5 ft.

The system may include packaging equipment to collect the clean crumb rubber and clean sand for reuse with a replacement carpet backing to install a replacement artificial turf. The system may further include vacuum equipment operating upon the mix of crumb rubber and sand.

An embodiment of an infill material reclamation method for artificial turf has also been disclosed. The method is implemented with a mobile recycling system. The artificial turf includes a backing fiber and fiber layer with infill material. The method includes transporting the mobile recycling system to a processing site which is selected to reduce a transport distance of artificial turf materials from an artificial turf site to the processing site. The method also includes operating the mobile recycling system at the processing site to: accept shredded pieces of artificial turf including the backing fiber and fiber layer with infill material in a first shredded minus product size; screen the first shredded minus product size to completely separate the infill material from the backing and fiber layer in a single stage to output the separated infill material in a second product minus size including a mix of sand and crumb rubber. The method also includes screening the mix of sand and crumb rubber from the single stage to separate the mix of sand and crumb rubber into clean crumb rubber and clean sand.

Optionally, the mobile recycling system includes at least one trailer apparatus configurable between a compact transport configuration and an operational configuration, the method further including: locating the at least one trailer apparatus on a processing site while in the compact transport configuration; and expanding the at least one trailer apparatus from the compact transport configuration at the processing site. The at least one trailer apparatus may include at least one machine rotatably mounted thereon and selectively positionable between a transport position and an operating position, the method including rotating the at least one machine from the transport position to the operating position at the processing site. The method may also include adding at least one screening machine to the at least one trailer apparatus at the processing site. The method may further include unfolding at least one conveyor on the at least one trailer apparatus at the processing site.

Furthermore, the method may include packaging the clean crumb rubber and clean sand for reuse with a replacement carpet backing to install a replacement artificial turf. The second product minus size may be about 21 times to about 37 times less than the first minus product size or about 67 times less than the first minus product size. The first product minus size may be about 8 inches (203 mm), and the second product minus may be is about 3 mm.

Screening the mix of sand and crumb rubber from the single stage to separate the mix of sand and crumb rubber into clean crumb rubber and clean sand may include screening the mix of sand and crumb rubber with a direct excitation screener to a 1 mm particle size to separate the crumb rubber and sand under conditions wherein the shredded material is dry and the crumb rubber material is not bonded to the sand, and operating at least one density table to separate particles having a minus product size of less than about 0.5 mm.

The method may optionally include applying low heat and high airflow volume to the mix of sand and crumb rubber to enhance a separation of the rubber crumb and sand. The applied low heat may be in a range of about 140° to about 180° F., about 110° to about 120° F., or about 85° to about 95° F.

The mobile recycling system may include at least one air knife, and the method may include operating the at least one air knife to remove detached fibers from the mix of rubber and sand. The method may include magnetizing at least one of the shredded pieces of artificial turf and the separated mix of sand and crumb rubber to remove metal material therefrom. The mobile recycling system may include a conveyor belt including a roller magnet, the roller magnet maintaining metal material on the conveyor belt while sand and rubber crumb particles fall from the conveyor belt. The mobile equipment may include a conveyor belt and an overhead magnet to remove metal material on the conveyor belt. The method may include vacuuming the mix of crumb rubber and sand.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A material reclamation system for artificial turf including a backing and fiber layer and infill material, the system comprising:
trommel screening equipment accepting shredded pieces of removed artificial turf including the backing and fiber layer and the infill material in a first shredded product minus size, the trommel screening equipment operable in a single stage to separate the infill material from the backing and fiber layer and output the separated infill material in a second product minus size including a mix of sand and crumb rubber; and
infill screening equipment accepting the mix of sand and crumb rubber from the single stage in the second product minus size and operable to separate the mix of sand and crumb rubber into clean crumb rubber and clean sand.

2. The system of claim 1, wherein the second product minus size is about 21 times to about 37 times less than the first minus product size.

3. The system of claim 1, wherein the second product minus size is about 67 times less than the first minus product size.

4. The system of claim 1, wherein the first product minus size is about 8 inches (203 mm).

5. The system of claim 2, wherein the second product minus size is about 3 mm.

6. The system of claim 1, wherein the infill screening equipment includes a direct excitation screener operable to screen the mix of sand and crumb rubber to a 1 mm particle size to separate the crumb rubber and sand under conditions wherein the shredded pieces of removed artificial turf are dry and the crumb rubber is not bonded to the sand.

7. The system of claim 6, wherein the infill screening equipment further includes a density table operable to separate particles having a minus product size of less than about 0.5 mm.

8. The system of claim 1, wherein the infill screening equipment applies low heat and high airflow volume to enhance a separation of the crumb rubber and sand.

9. The system of claim 8, wherein the applied low heat is in a range of about 140° to about 180° F.

10. The system of claim 8, wherein the applied low heat is in a range of about 110° to about 120° F.

11. The system of claim 8, wherein the applied low heat is in a range of about 85° to about 95° F.

12. The system of claim 1, further comprising at least one air knife operable to remove detached fibers from the mix of crumb rubber and sand.

13. The system of claim 1, wherein the system is a mobile system.

14. The system of claim 13, wherein the mobile system includes an expandable trailer apparatus.

15. The system of claim 14, wherein the expandable trailer apparatus includes at least one machine that is rotatably mounted on the expandable trailer apparatus and is rotatably positionable between a transport position and an operating position.

16. The system of claim 15, wherein in the transport position the at least one machine has a height of about 13.5 ft or less, and in the operating position the machine has a height greater than 13.5 ft.

17. The system of claim 1, further comprising packaging equipment to collect the clean crumb rubber and clean sand for reuse with a replacement carpet backing to install a replacement artificial turf.

18. The system of claim 1, further comprising vacuum equipment operating upon the mix of crumb rubber and sand.

19. An infill material reclamation method for artificial turf, the method implemented with a mobile recycling system, the artificial turf including a backing fiber and fiber layer with infill material, wherein the method comprises:
transporting the mobile recycling system to a processing site which is selected to reduce a transport distance of artificial turf materials from an artificial turf site to the processing site; and
operating the mobile recycling system at the processing site to:
accept shredded pieces of artificial turf including the backing fiber and fiber layer with infill material in a first shredded minus product size;
screen the first shredded minus product size to completely separate the infill material from the backing and fiber layer in a single stage to output the separated infill material in a second product minus size including a mix of sand and crumb rubber; and
screening the mix of sand and crumb rubber from the single stage to separate the mix of sand and crumb rubber into clean crumb rubber and clean sand.

20. The method of claim 19, wherein the mobile recycling system includes at least one trailer apparatus configurable between a compact transport configuration and an operational configuration, the method further comprising:
locating the at least one trailer apparatus on a processing site while in the compact transport configuration; and
expanding the at least one trailer apparatus from the compact transport configuration at the processing site.

21. The method of claim 20, wherein the at least one trailer apparatus includes at least one machine rotatably mounted thereon and selectively positionable between a transport position and an operating position, the method comprising:
rotating the at least one machine from the transport position to the operating position at the processing site.

22. The method of claim 21, further comprising adding at least one screening machine to the at least one trailer apparatus at the processing site.

23. The method of claim 22, further comprising unfolding at least one conveyor on the at least one trailer apparatus at the processing site.

24. The method of claim 19, further comprising packaging the clean crumb rubber and clean sand for reuse with a replacement carpet backing to install a replacement artificial turf.

25. The method of claim 19, wherein the second product minus size is about 21 times to about 37 times less than the first minus product size.

26. The method of claim 19, wherein the second product minus size is about 67 times less than the first minus product size.

27. The method of claim 19, wherein the first product minus size is about 8 inches (203 mm).

28. The method of claim 27, wherein the second product minus size is about 3 mm.

29. The method of claim 19, wherein screening the mix of sand and crumb rubber from the single stage to separate the mix of sand and crumb rubber into clean crumb rubber and clean sand comprises screening the mix of sand and crumb rubber with a direct excitation screener to a 1 mm particle size to separate the crumb rubber and sand under conditions wherein the shredded material is dry and the crumb rubber material is not bonded to the sand.

30. The method of claim 29, wherein screening the mix of sand and crumb rubber from the single stage to separate the mix of sand and crumb rubber into clean crumb rubber and clean sand further comprises operating at least one density table to separate particles having a minus product size of less than about 0.5 mm.

31. The method of claim 19, further comprising applying low heat and high airflow volume to the mix of sand and crumb rubber to enhance a separation of the rubber crumb and sand.

32. The method of claim 31, wherein the applied low heat is in a range of about 140° to about 180° F.

33. The method of claim 31, wherein the applied low heat is in a range of about 110° to about 120° F.

34. The method of claim 31, wherein the applied low heat is in a range of about 85° to about 95° F.

35. The method of claim 19, the mobile recycling system including at least one air knife, the method further comprising operating the at least one air knife to remove detached fibers from the mix of rubber and sand.

36. The method of claim 19, further comprising magnetizing at least one of the shredded pieces of artificial turf and the separated mix of sand and crumb rubber to remove metal material therefrom.

37. The method of claim 36, wherein the mobile recycling system includes a conveyor belt including a roller magnet, the roller magnet maintaining metal material on the conveyor belt while sand and rubber crumb particles fall from the conveyor belt.

38. The method of claim 36, wherein the mobile equipment includes a conveyor belt and an overhead magnet to remove metal material on the conveyor belt.

39. The method of claim 19, further comprising vacuuming the mix of crumb rubber and sand.
